(19) United States
(12) Patent Application Publication
(10) Pub. No.: US 2007/0068307 A1
(43) Pub. Date: Mar. 29, 2007

(54) Device for producing a combined linear and transversal movement

(75) Inventor: Walter Mann, Bremen (DE)

Correspondence Address: Fulbright & Jaworski, Fulbright Tower Suite 5100, 1301 McKinney, Houston, TX, 77010-3095, US

(73) Assignee: Suhling Technik, Bremen (DE)

(21) Appl. No.: 10/575,959

(22) PCT Filed: Oct. 12, 2004
(86) PCT No.: PCT/DE04/02255

§ 371 Date: Nov. 29, 2006

(30) Foreign Application Priority Data
Oct. 13, 2003 (DE) 103 48 078.1

(51) Int. Cl. B25J 9/10; F16H 37/14

(52) U.S. Cl. 74/480 R

(57) ABSTRACT

Device for generating a composite movement comprising, in a first movement section, a linear movement running in a longitudinal direction and, in a subsequent second movement section, a predetermined transverse movement including a component perpendicular to the longitudinal direction, the device comprising a linear member movably guided in the longitudinal direction and a transverse member movably guided on the linear member along a compensatory movement path, the compensatory movement path including directional components in the longitudinal direction and perpendicular thereto, and said transverse member being mechanically forcibly guided within the second movement section of the linear member in order to execute a relative displacement in the longitudinal direction between the transverse member and the linear member such that, as a consequence of a kinematic superposition of the linear movement and a forcibly guided movement along the compensatory movement path, the predetermined transverse movement of the transverse member results.

### CROSS-REFERENCE TO RELATED APPLICATIONS

This application is a national stage application of PCT/DE2004/002255 filed Oct. 12, 2004 claiming priority to DE 103 48 078.1 filed Oct. 13, 2003.

### TECHNICAL FIELD

The invention relates to a device for generating a composite movement comprising, in a first movement section, a linear movement running in a longitudinal direction and, in a subsequent second movement section, a predetermined transverse movement including a component perpendicular to the longitudinal direction, as set forth in claim 1.

### BACKGROUND OF THE INVENTION

The problem of the invention consists in creating a device for generating a movement composed of a linear movement and a subsequent transverse movement of, for example, a gripper member, said device making it possible to generate rapid accelerations despite being simple in design, i.e. with which short cycle times are possible when performing working cycles with reciprocating movements.

This problem is solved in accordance with the invention by a device for generating a composite movement comprising, in a first movement section, a linear movement running in a longitudinal direction and, in a subsequent second movement section, a predetermined transverse movement including a component perpendicular to the longitudinal direction, the device comprising a linear member movably guided along the longitudinal direction and a transverse member movably guided on the linear member along a compensatory movement path, the compensatory movement path including directional components in the longitudinal direction and perpendicular thereto, and the transverse member being mechanically forcibly guided within the second movement section of the linear member in order to execute a relative displacement in the longitudinal direction between the transverse and linear members, such that, as a consequence of a kinematic superposition of the linear movement and a forcibly guided movement along the compensatory movement path, the predetermined transverse movement of the transverse member results.

### BRIEF SUMMARY OF THE INVENTION

The device of the invention can be used, for example, in the field of injection technology, where, within short cycle times, finished moulded articles have to be removed from moulds between opened mould halves, and/or where inserts, such as labels, have to be placed in a mould cavity.

The invention preferably provides that the transverse movement is straight and runs at a predetermined angle to the longitudinal direction.

It may be appropriate for the compensatory movement path to run in a straight line.

One preferred embodiment provides that the transverse movement runs perpendicular to the longitudinal direction.

It may be appropriate for the compensatory movement path to run in a straight line at 45° to the longitudinal direction. In this case, it may be advantageous for the transverse member to be forcibly guided in such a way that, within the second movement section of the linear member, it remains absolutely still in the longitudinal direction, so that, relative to the linear member, it is displaced in the longitudinal direction, corresponding to the linear movement thereof, but in the opposite direction.

In one embodiment, it is provided that the transverse member is forcibly guided by means of a slide rod.

The slide rod may, at a first end, be pivotably connected to the transverse member and, at a second end, be guided by means of a stationary guide path having one part running in the longitudinal direction, corresponding to the first movement section, and one part running perpendicular to the longitudinal direction, corresponding to the second movement section. A curved transition portion may be provided between the first and second parts.

One advantageous embodiment is characterised by the fact that the second end of the slide rod is pivotably connected to a free end of a pivoting lever which is mounted on the linear member and is connected in a torsionally resistant manner to a control lever, the free end of which is guided in the guide path.

It may be provided that a holding and/or gripping means is arranged on the transverse member for holding, picking up and/or putting down an article.

### BRIEF DESCRIPTION OF THE DRAWINGS

The invention will now be described in more detail on the basis of a working embodiment with reference to a drawing, in which

FIG. 1 shows a side view of a linear member of a device according to the invention;

FIG. 2 shows a top plan view of a device according to the invention with a linear member in accordance with FIG. 1;

FIGS. 3 to 6 show top plan views of the device according to FIG. 2 in an initial position (FIG. 3, corresponds to FIG. 2), in an intermediate position (FIG. 4), in a further position (FIG. 5) and in an actuating position (FIG. 6); and

FIGS. 7 to 10 show major components of the device of the invention in the initial position (FIG. 7, corresponds to FIG. 3), the intermediate position (FIG. 8, corresponds to FIG. 4), the further position (FIG. 9, corresponds to FIG. 5) and the actuating position (FIG. 10, corresponds to FIG. 6).

### DETAILED DESCRIPTION OF THE INVENTION

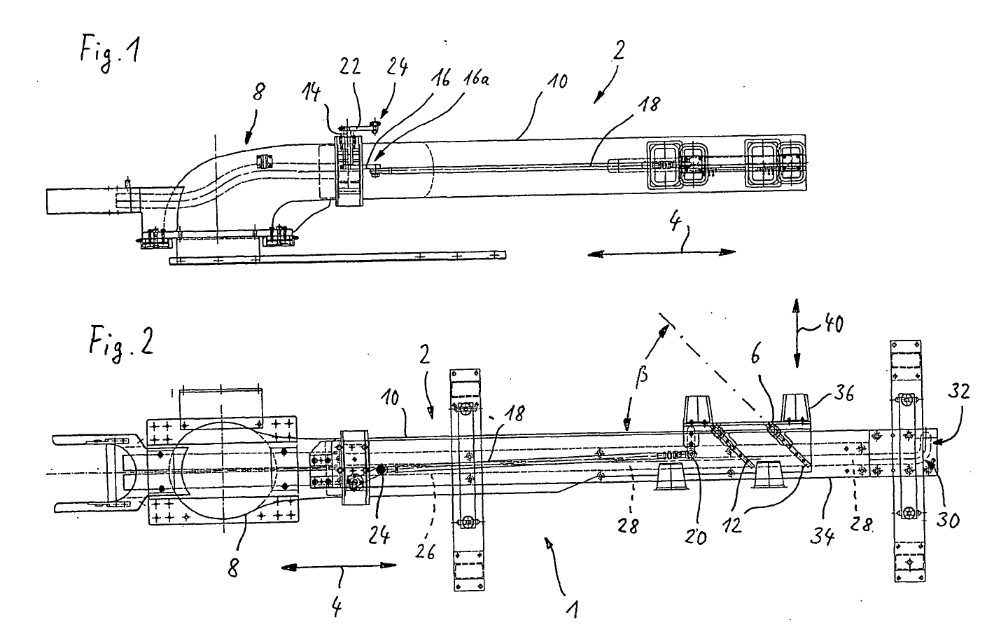

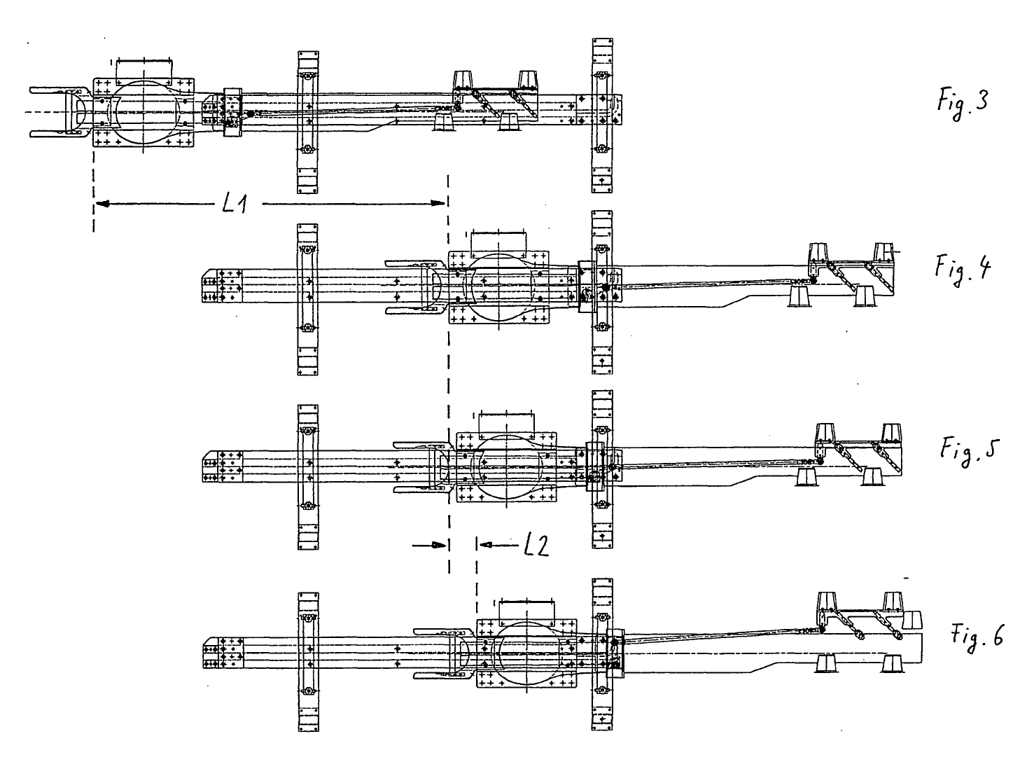

FIGS. 1 and 2 illustrate the general construction of a device according to the invention for generating a composite movement, which, in the embodiment shown, is implemented in the form of an insertion device 1 used for inserting labels into mould cavities of two-part injection moulds during the production of plastic containers in so-called “inmould-labelling processes”. The problem here consists in accurately inserting labels made of thin plastic material in the correct position in mould cavities of a two-part injection mould (not shown), and in doing so within the short period in which the mould is open and in which the plastic containers produced during the previous working cycle must also be removed at the same time. The sequence of movements to be performed by a holding device for the labels to be inserted consists of a straight movement starting from a position outside the injection mould to inside the injection mould at the level of the mould cavity, and then, starting from that position, into the mould cavity in a direction perpendicular to the previous movement. After putting down the label in the mould cavity, e.g. by means of electrostatic forces, the holding device performs the sequence of movements described above in the opposite direction, two finished parts being removed in the process.

FIG. 1 shows a side view of a linear member 2, which can be moved to and fro in a straight line in the longitudinal direction 4 on a linear guide, which is not shown in detail (slideway or linear guidance system with recirculating linear ball bearings), the drive being provided by a motor (not shown).

The linear member 2 is tubular in overall structure and has a root portion 8 offset by 90° and a substantially cylindrical cantilever portion 10. The root portion 8 serves to provide a mount and holds the drive, while the cantilever portion 10 serves to execute the holding and/or gripping functions of the insertion device.

As FIG. 2 shows, in which a top plan view of the insertion device 1 is illustrated, the linear member 2 bears, at its free end at the end of the cantilever portion 10, a transverse member 6. The transverse member 6, which is held and guided on the linear member 2, can be moved relative thereto along compensatory movement paths 12 and bears two conical holding means 36, corresponding to the shape of the containers to be produced in the injection moulding machine to be operated, for inserting labels. In the embodiment illustrated, the compensatory movement paths 12 run straight (linear guides) and form an angle β of 45° to the longitudinal direction 4 (direction of movement) of the linear member 2.

In the region of the transition between the root portion 8 and the cantilever portion 10 of the linear member 2, a lever arbor 14 is rotatably attached to the linear member 2, at one end of which there is a pivoting lever 16, the free end 16a of which is pivotably connected to a first end of a slide rod 18, the other end of which is coupled to a drag bearing 20 with the transverse member 6.

On the lever arbor 14 there is also a control lever 22 in the same angular alignment as the pivoting lever 16, so that in the top plan view (along the axial direction of the lever arbor 14) in FIGS. 2 to 8 only the control lever 22 is visible. On a free end of the control lever 22 there is a guide roller 24, which is guided in a stationary guide path 26, which is indicated in outline. As FIG. 2 shows, the guide path 26 has a straight portion 28, at the end of which is a 90° arcuate portion 30, after which there is another straight portion 32, which is aligned perpendicular to the straight portion 28. The guide path 26 comprising the three portions described may be designed, for example, as a groove-like indentation in the underside of a stationary, horizontal guide plate 34 attached above the linear member 2. When the linear member 2 moves, the guide roller 24 then moves in the longitudinal direction 4 or in a transverse direction 40 along the guide path 26.

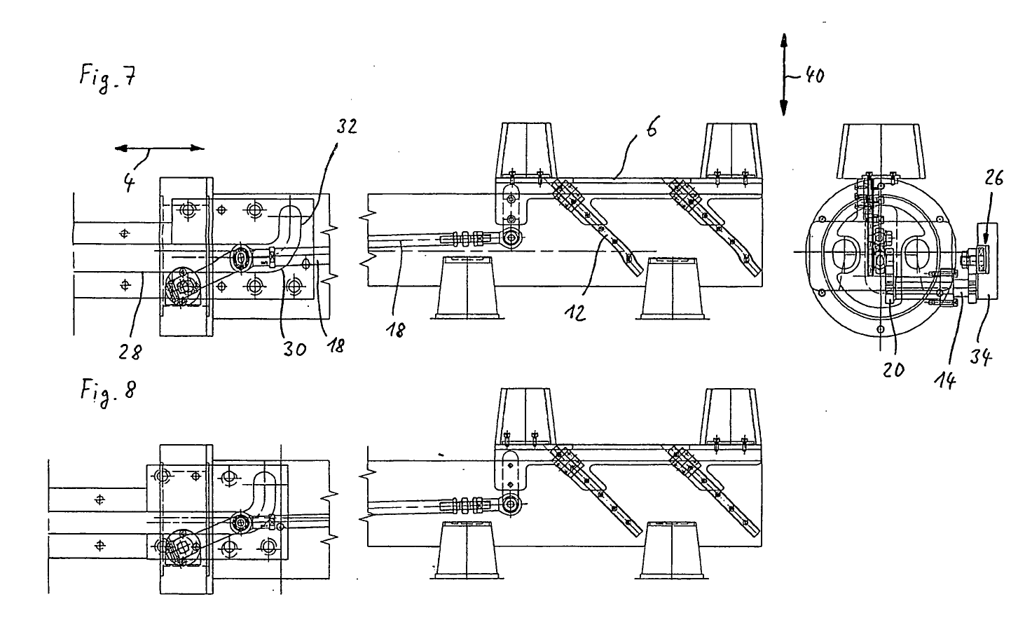

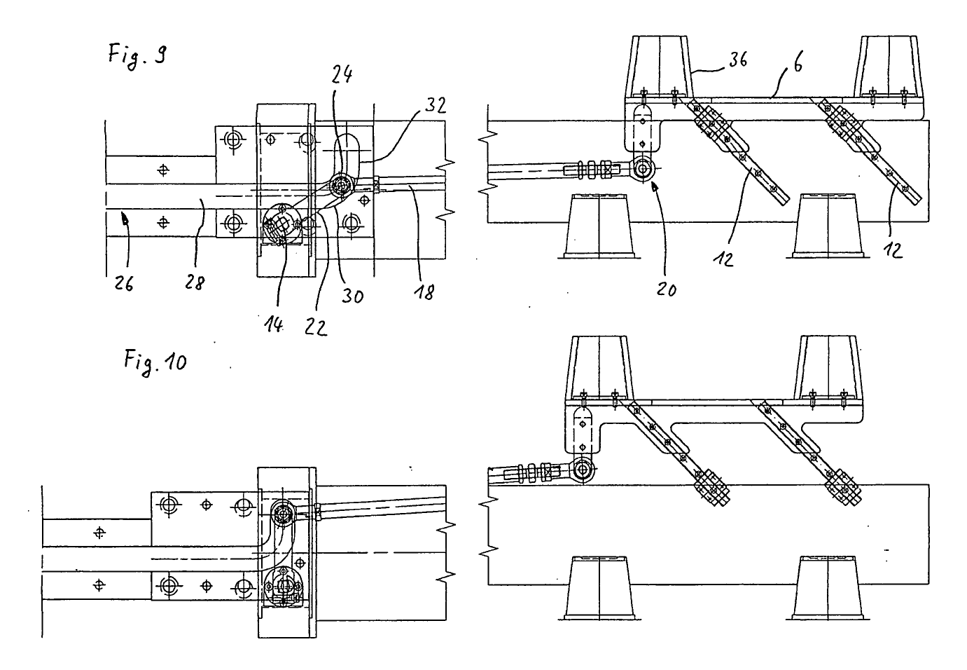

FIGS. 3 to 6 illustrate the functioning of the insertion device 1 of the invention, FIG. 3 being an illustration in accordance with FIG. 2 on a reduced scale. Attention is also drawn to FIGS. 7 to 10, which illustrate on an enlarged scale the regions of the insertion device 1 relevant to the sequences of movements essential to the invention, namely the lever arbor 14 with the pivoting lever 16 and the control lever 22, and the transverse member 6 with the compensatory movement paths 12.

The first, straight movement section of the linear member 2 is designated L1 and corresponds to that part of the straight portion 28 of the guide path 26 which is located between its one end in the position of the guide roller 24 according to FIGS. 2, 3 and the beginning of the 90° portion 30. When the linear member 2 moves within this first movement section L1, the control lever 22 maintains its position relative to the linear member 2 unchanged, so that the positions of the slide rod 18 and the transverse member 6 also remain unchanged relative to the linear member 2.

As soon as the linear member 2, moving towards the right, proceeding from the initial position shown in FIG. 3, has reached a point at which the guide roller 24 enters the 90° portion 30 (intermediate position), the second movement section L2 begins. FIG. 4 shows the position of the linear member 2 in this position, i.e. at the end of the first movement section L1 and at the beginning of the second movement section L2. FIG. 5 shows a further position of the linear member 2, in which the guide roller 24 has already partially passed through the 90° portion 30.

FIG. 6 shows the linear member 2 in its end position (actuating position), after it has passed completely through the second movement section L2. As can be seen in greater detail in FIGS. 8 to 10, the entry of the guide roller 24 into the 90° portion 30 of the guide path 26 causes the control lever 22 and thus also the pivoting lever 16 to begin an increasingly rapid pivoting movement about the lever arbor 14, running in an anti-clockwise direction in the top plan view, at the beginning of the second movement section L2, which leads to a relative movement between the guide roller 24 and the linear member 2 and thus also to a relative movement between the slide rod 18 and the linear member 2 in the longitudinal direction 4. The relative movement perpendicular to the longitudinal direction 4 which occurs at the same time because of the pivoting movement of the guide roller 24 and the concomitant slight change in the alignment of the slide rod 18 is basically negligible in this connection. As soon as the guide roller 24 has reached the end of the 90° portion 30 and the transition portion to the straight portion 32 of the guide path 26, the guide roller 24 comes to an absolute standstill when seen in the longitudinal direction 4 and is displaced relative to the linear member 2 to the same extent as the latter moves relative to the guide plate, i.e. corresponding to its longitudinal movement.

The relative movement between the slide rod 18 and the linear member 2 within the second movement section L2 of the linear member 2, as just described, causes a relative movement of the transverse member 6, running in the same direction when seen in the longitudinal direction 4. This means that the transverse member 6 stands still in absolute terms as soon as the guide roller 24 is prevented from moving further in the longitudinal direction 4 because of the guide path 26 (portion 32).

Owing to the kinematic forced coupling between the transverse member 6 and the linear member 2 by the compensatory movement path 12, which is orientated at 45° to the longitudinal direction 4, the relative movement described above leads to a forcibly guided movement of the transverse member 6 in the transverse direction 40. This resulting transverse movement is exactly perpendicular to the longitudinal direction 4 while the guide roller is located within the portion 32, disregarding the inaccuracies due to mechanical reasons because of the displacement of the guide roller 24 transversely to the longitudinal direction 4.

In this embodiment, the predetermined transverse movement of the transverse member 6 runs perpendicular to the longitudinal movement of the linear member 2, and, in the process, a superposition of a movement along the longitudinal direction 4 and a movement along the compensatory movement path 12 leads to the desired transverse movement. Since the slide rod 18 causes the guide path 26 to produce a forced guidance of the transverse member 6 along the compensatory movement path 12, the resulting transverse movement of the transverse member 6 is determined not only by the shape and direction of the compensatory movement path 12, but also by the way in which the transverse member is guided along the compensatory movement path, i.e. the relative displacement of the transverse member 6 along the compensatory movement path as a function of the longitudinal movement of the linear member 2 in the longitudinal direction 4. The straight portion 32 of the guide path 26 could, for example, run at an inclined angle other than 90° to the longitudinal direction 4, which would then result in a transverse movement of the transverse member 6 which would likewise be orientated at an angle other than 90° to the longitudinal direction 4. Conversely, arranging the straight compensatory movement path 12 at an angle other than 45° to the longitudinal direction 4 would likewise produce a corresponding displacement of the resulting direction of the transverse movement of the transverse member 6.

Transverse movements of the transverse member 6 which are not straight are also possible, provided that either the compensatory movement path 12 does not run straight or that the relative displacement of the transverse member 6 during the movement of the linear member 2 within the second movement section does not run in a linear manner. One example of this can already be seen in the 90° portion 30 of the guide path 26, which results in a corresponding arcuate displacement of the transverse member 6, which is desirable and necessary in practice, in order to avoid excessively great mass forces at the end of the linear movement L1, owing to acceleration.

While the transverse member 6 is implemented as an insertion member for a label in the embodiment described, a very wide variety of other embodiments are also conceivable, such as in a pick-and-place application, where a gripping means is disposed on the transverse member and any article must be picked up in the appropriate orientation in the initial position and placed down in the actuating position or vice versa. It goes without saying that the transverse movement may occur in any appropriate orientation, i.e. vertically upwards or downwards, sideways or in an inclined direction.

### LIST OF REFERENCE NUMERALS

1 Insertion device
2 Linear member
4 Longitudinal direction
6 Transverse member
8 Root portion
10 Cantilever portion
12 Compensatory movement path
14 Lever arbor
16 Pivoting lever
16a Free end
18 Slide rod
20 Drag bearing
22 Control lever
24 Guide roller
26 Guide path
28 Straight portion
30 90° portion
32 Straight portion
34 Guide plate
40 Transverse direction
L1 First movement section
L2 Second movement section
β Angle between 12 and 4

1. A device for generating a composite movement comprising:
a first movement section having a linear movement running in a longitudinal direction;
a subsequent second movement section having a predetermined transverse movement including a component perpendicular to the longitudinal direction;
wherein said device comprise a linear member movably guided in the longitudinal direction and a transverse member movably guided on the linear member along a compensatory movement path, said compensatory movement path including directional components in said longitudinal direction and perpendicular thereto, and said transverse member being mechanically forcibly guided within said second movement section of said linear member in order to execute a relative displacement in said longitudinal direction between said transverse member and said linear member such that, as a consequence of a kinematic superposition of the linear movement and a forcibly guided movement along said compensatory movement path, the predetermined transverse movement of said transverse member results.

2. The device as claimed in claim 1, wherein the transverse movement is straight and runs at a predetermined angle β to the longitudinal directions.

3. The device as claimed in claim 1, wherein the compensatory movement path runs in a straight line.

4. The device as claimed in claim 1, wherein the transverse movement runs perpendicular to the longitudinal direction.

5. The device as claimed in claim 1, wherein the compensatory movement path runs in a straight line at 45° to the longitudinal direction.

6. The device as claimed in claim 5, wherein the transverse member is forcibly guided in such a way that, within the second movement section of the linear member the transverse member remains absolutely still in the longitudinal direction, so that, relative to the linear member, it is displaced in the longitudinal direction, corresponding to the linear movement thereof, but in the opposite direction.

7. The device as claimed in claim 1, wherein the transverse member is forcibly guided by means of a slide rod.

8. The device as claimed in claim 7, wherein the slide rod is, at a first end, pivotably connected to the transverse member and, at a second end, guided by means of a stationary guide path, having one part running in the longitudinal direction, corresponding to the first movement section, and one part running perpendicular to the longitudinal direction, corresponding to the second movement section.

9. The device as claimed in claim 8, wherein a curved transition portion is provided between the first part, running in the longitudinal direction, and the second part, running perpendicular to the longitudinal direction.

10. The device as claimed in claim 8, wherein the second end of the slide rod is pivotably connected to a free end of a pivoting lever which is mounted on the linear member and is connected in a torsionally resistant manner to a control lever the free end of which is guided in the guide path.

11. The device as claimed in claim 1, wherein a holding and/or gripping means is arranged on the transverse member for holding, picking up and/or putting down an article.
